(19) United States
(12) Patent Application Publication
(10) Pub. No.: US 2016/0341703 A1
(43) Pub. Date: Nov. 24, 2016

(54) ULTRASONIC TEST APPARATUS AND METHOD FOR ULTRASONIC TESTING

(71) Applicant: SIEMENS AKTIENGESELLSCHAFT, München (DE)

(72) Inventor: STEFAN OBERMAYR, DUISBURG (DE)

(21) Appl. No.: 15/111,492

(22) PCT Filed: Dec. 15, 2014
(86) PCT No.: PCT/EP2014/077711

§ 371 Date: Jul. 14, 2016

(30) Foreign Application Priority Data
Jan. 22, 2014 (DE) 102014201129.9

(51) Int. Cl. G01N 29/46

(52) U.S. Cl. CPC G01N 29/46; G01N 2291/044; G01N 2291/0289

(57) ABSTRACT

An ultrasonic test apparatus including a test head for emitting an emission frequency spectrum having an emission center frequency and receiving a reception frequency spectrum having a reception center frequency, a unit being provided in which a Fourier transform on the received reception frequency spectrum can be carried out, and the reception center frequency of the Fourier-transformed reception frequency spectrum being subsequently determined, and subsequently a defined add-on amplification being applied to the reception frequency spectrum. Also, a method for ultrasonic testing is disclosed.

### CROSS-REFERENCE TO RELATED APPLICATIONS

This application claims priority to PCT Application No. PCT/EP2014/077711, having a filing date of Dec. 15, 2014, based off of DE Application No. 10 2014 201 129.9 having a filing date of Jan. 22, 2014, the entire contents of which are hereby incorporated by reference.

### FIELD OF TECHNOLOGY

The following relates to an ultrasonic test apparatus comprising a test head for emission of an emission frequency spectrum having an emission central frequency and reception of a reception frequency spectrum and also a method for ultrasonic testing.

### BACKGROUND

Ultrasonic testing is a widespread method for nondestructive material testing. In this case, the comparatively unobstructed propagation, which is well aligned at the high frequencies used, of ultrasound in solid bodies is used to detect flaws, at which sound waves are reflected.

Various test head frequencies are used in ultrasonic material testing—depending on the testing task, material, and component geometry. High frequencies offer better test sensitivities and location resolution capability as a result of the wavelength and directional characteristic thereof, while in contrast low frequencies are generally more sensitive to unfavorably oriented flaws due to the broader sound bundle thereof. Therefore, different frequencies are often used for the same testing task. The low frequencies are used in this case as a search technique and the high frequencies are used for the more accurate location and measurement of smaller flaws.

However, this circumstance is time-consuming, since test runs have to be carried out twice to ensure that the tool coordinates of both test runs are identical, to be able to compare the results.

For example, in large-volume steam turbine rotors, tests are firstly carried out at 2 MHz to be able to find as many flaws as possible from the volume and are repeated in a second step at 4 MHz, to be able to make a more accurate size statement and find the position of the flaw.

### SUMMARY

An aspect relates to an ultrasonic test apparatus, which solves the above-mentioned problem. A second aspect is to specify a method for ultrasonic testing, which solves the above-mentioned problem.

The first aspect is achieved by the specification of an ultrasonic test apparatus, comprising a test head for emission of an emission frequency spectrum having an emission central frequency and reception of a reception frequency spectrum. According to embodiments of the invention, a unit is provided, in which a Fourier transform can be carried out on the received reception frequency spectrum, and wherein subsequently a reception central frequency of the Fourier-transformed reception frequency spectrum is ascertainable, and wherein subsequently a defined amplification supplement can be applied to the reception frequency spectrum.

There are test heads, in particular broadband test heads, which cover a specific spectrum of frequencies. However, the spectrum is subject to a significant drop of the intensity around the central frequency.

Therefore, reflected echo signals from lower or higher frequencies are displayed with a correspondingy lower amplitude on the ultrasonic device.

For example, a signal which only comes to reflection by 2 MHz due to an unfavorable flaw orientation is displayed on the ultrasonic device with an intensity which is less by approximately 18 dB. Detectability would therefore generally no longer be provided.

According to embodiments of the invention, it has therefore been recognized that ultrasonic devices do not indicate any items of information about the frequency band of individual echoes.

According to embodiments of the invention, it has furthermore been recognized that such a test head, which is broadband in particular, in principle emits all frequencies required for the testing, whereby all desired reflection conditions are also generated at a flaw.

Echoes registered by the ultrasonic device, i.e., the reception frequency spectrum, pass through a Fourier transform. Each echo, in particular echoes which can be registered and separated with respect to time, is analyzed in this case with regard to its frequency band and assigned its own reception central frequency. Subsequently, a defined amplification supplement is applied to the reception frequency spectrum.

The amplification supplement is preferably the difference of the emission central frequency and the reception central frequency. That is to say, since the sensitivity curve of the frequency band of a test head is known, the relevant echo can subsequently be displayed increased by the amplification supplement, which deviates from the emission central frequency.

The test head is preferably a broadband test head, for emission of a broadband emission frequency spectrum having an emission central frequency and reception of a broadband reception frequency spectrum. However, other suitable test heads can also be used. In this case, broadband test heads are understood as test heads having large bandwidth. The bandwidth establishes the breadth of the interval in a frequency spectrum in which the dominant frequency components of a signal to be transmitted or stored are located. The bandwidth is usually characterized by a lower and an upper limit frequency.

The unit is preferably arranged in the test head itself. The unit can also be connected downstream of the test head as a module unit. That is to say, the Fourier transform and the subsequent computational steps can be performed within the test head itself or in a downstream module unit. The unit itself can be embodied as a simple computer unit.

The second aspect is achieved by the specification of a method for ultrasonic testing using a test head for emission of an emission frequency spectrum having an emission central frequency and reception of a reception frequency spectrum having a reception central frequency comprising the following steps:
carrying out a Fourier transform on the received reception frequency spectrum,
ascertaining the reception central frequency of the Fourier-transformed reception frequency spectrum, and
applying a defined amplification supplement to the reception frequency spectrum.

In particular, the test head is designed as a broadband test head, for emission of a broadband emission frequency spectrum having an emission central frequency and reception of a broadband reception frequency spectrum.

By way of the method according to embodiments of the invention, separate testing using low and high frequencies is omitted, since all required frequencies are already contained in a broadband test head.

The difference of the emission central frequency and the reception central frequency is preferably calculated as the amplification supplement. However, other suitable amplification supplements can also be used.

In a preferred embodiment, flaws in the sound-tested object are detected using the pulse-echo technique.

Flaws can be detected in through-transmission or with the aid of the pulse-echo technique. In the first case, the transmitted sound intensity decreases and in the second case, additional reflections between the entry echo and the rear wall echo are analyzed.

The Fourier transform is preferably carried out in real time or only after a data recording.

### BRIEF DESCRIPTION

Some of the embodiments will be described in detail, with reference to the following figures, wherein like designations denote like members, wherein:

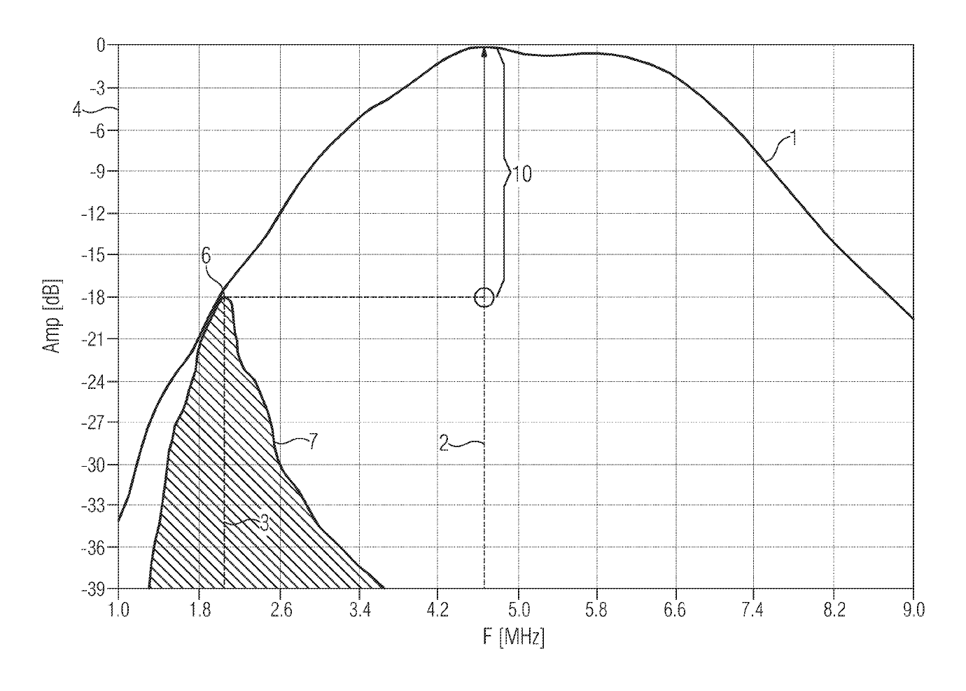

FIG. 1: schematically shows an emission spectrum and a reception frequency spectrum.

### DETAILED DESCRIPTION

Different frequencies are fundamentally used in ultrasonic testing. In general, test heads having a narrow frequency band are used for this purpose. For example, solely 2 MHz test heads are used to find flaws having unfavorable alignments, and solely 4 MHz test heads are used to determine the extent of flaws which are found.

There are broadband test heads which cover a specific emission frequency spectrum 1. FIG. 1 shows an example of such an emission frequency spectrum 1. This spectrum is subject to a significant decrease of the intensity around an emission central frequency 2, however.

Therefore, reflected reception frequency spectra 7, i.e., echo signals made of lower and/or higher frequencies are displayed with a correspondingly lower amplitude 4 on the ultrasonic device.

For example, a signal 3 in the emission frequency spectrum 1, which only reaches reflection by 2 MHz due to an unfavorable flaw orientation, is displayed on the ultrasonic device with an intensity which is lower by approximately 18 dB. Detectability is therefore generally no longer provided.

Since a broadband test head in principle emits all frequencies required for the testing, all desired reflection conditions are also generated at a flaw. According to embodiments of the invention, a Fourier transform is therefore carried out using the received reception frequency spectrum 7. Subsequently, the reception central frequency 6 of the Fourier-transformed reception frequency spectrum is ascertained, and a defined amplification supplement 10 is applied to the reception frequency spectrum 7.

This means that the reception frequency spectrum 7 registered by the device—in real time or only after the data recording, depending on the computing power—passes through a Fourier transform. Every reception frequency spectrum 7 which can be registered and separated with respect to time is analyzed in this case with regard to its frequency band and assigned to a separate reception central frequency 6. The sensitivity curve of the frequency band of a test head is known, i.e., the relevant echo having the reception central frequency 6 can subsequently be displayed increased by the amplification supplement 10, which deviates from the emission central frequency 2.

Here, for example, a reception frequency spectrum 7, which can be separated from noise and other signals, is separated at 10% display screen level, its reception central frequency 6 is established to be 2 MHz via the Fourier transform, and it is amplified by 18 dB in accordance with an amplification supplement 10.

The same reception frequency spectrum 7 is thus now displayed with a display screen level of 80% and can thus be analyzed as if a test/measurement had taken place only with a 2 MHz head.

According to embodiments of the invention, by way of the frequency-band-dependent adaptation of the displayed amplitude intensities, testing is performed over the entire spectrum of reasonable frequencies with uniform sensitivity using only one test run. An amplitude evaluation is generally more informative, since the intensity distribution specific to the test head is compensated for. According to embodiments of the invention, testing using low and high frequencies separately is omitted. Further signal processing of the received signal spectrum is therefore described according to embodiments of the invention.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1-6. (canceled)

7. An ultrasonic test apparatus comprising a test head for emission of an emission frequency spectrum having an emission central frequency and reception of a reception frequency spectrum having a reception central frequency,
comprising:
a unit, wherein a Fourier transform can be carried out on the received reception frequency spectrum, and wherein subsequently the reception central frequency of the Fourier-transformed reception frequency spectrum is ascertainable, and wherein subsequently a defined amplification supplement can be applied to the reception frequency spectrum, wherein the test head is a broadband test head, for emission of a broadband emission frequency spectrum having an emission central frequency and reception of a broadband reception frequency spectrum.

8. The ultrasonic test apparatus as claimed in claim 7, wherein the amplification supplement is the difference of the emission central frequency and the reception central frequency.

9. The ultrasonic test apparatus as claimed in claim 7, wherein the unit is arranged in the test head itself.

10. The ultrasonic test apparatus as claimed in claim 7, wherein the unit is connected downstream of the test head as a module unit.

11. A method for ultrasonic testing using a test head for emission of an emission frequency spectrum having an emission central frequency and reception of a reception frequency spectrum having a reception central frequency,
comprising the following steps:
carrying out a Fourier transform on the received reception frequency spectrum,
ascertaining the reception central frequency of the Fourier-transformed reception frequency spectrum,
applying a defined amplification supplement to the reception frequency spectrum.
